(19) United States
(12) Patent Application Publication
(10) Pub. No.: US 2014/0251303 A1
(43) Pub. Date: Sep. 11, 2014

(54) HEATING DEVICE

(71) Applicants: Matthew John Searle, Bruton (GB); Paul Sleeman, Kingswood (GB); Marc Lamensdorf, St. James, NY (US); Steven Lamensdorf, St. James, NY (US)

(72) Inventors: Matthew John Searle, Bruton (GB); Paul Sleeman, Kingswood (GB); Marc Lamensdorf, St. James, NY (US); Steven Lamensdorf, St. James, NY (US)

(73) Assignee: Genergy Technology Limited, Banstead Surrey (GB)

(21) Appl. No.: 14/238,166

(22) PCT Filed: Aug. 17, 2012
(86) PCT No.: PCT/GB2012/052018

§ 371 Date: May 22, 2014

(30) Foreign Application Priority Data
Aug. 19, 2011 (GB) 1114285.8

(51) Int. Cl. A47J 36/28

(52) U.S. Cl. CPC A47J 36/28
USPC 126/263.09

(57) ABSTRACT

There is provided a heating device based on an exothermic reaction between first and second substances. The device comprises a first cavity holding the first substance, a second cavity holding the second substance, and a first barrier layer therebetween. The device further comprises a rotatable breaking element for rotating to breach the first barrier layer, thereby allowing mixing of the first and second substances to start the reaction.

The present invention relates to a heating device, and more particularly to a device that utilises an exothermic reaction to perform the heating. Various embodiments of the invention use the heating device to heat the contents of a container.

The contents of the container may for example be a beverage or a foodstuff that is preferably heated before consumption. Whilst plenty of methods for heating foodstuffs are known in the art, these are not always available or convenient when the consumer is out-of-doors or travelling.

A known device for heating the contents of a container is described in the document WO 2006/024852. A steam generator comprises a first chamber with a first substance that reacts exothermically with a second substance in a second chamber to produce steam. A frangible barrier is provided between one of the chambers and a steam outlet, and another frangible barrier between the two chambers. The frangible barriers are ruptured by piecing them to mix the substances and allow the resultant steam to exit.

Various substances that may be mixed together to generate heat are known to those skilled in the art, for example mixtures of calcium oxide and water, or mixtures of magnesium-iron alloys and saline solution.

One of the problems with such devices that employ frangible barriers between two substances, is the difficulty of rupturing the barrier sufficiently well that the substances mix freely and result in the desired chemical reaction. Even after rupture, known devices often require vigorous shaking in order for the substances to pass through the barrier and mix. Inefficient mixing of the substances can result in low heat output and/or a prolonged amount of time being required for the heating device to output the required amount of heat. Furthermore, in heating devices where steam is the primary output, a slow reaction may prevent the device from generating the required amount of steam quickly enough to build up a desired steam pressure.

Other considerations are that the reaction should not be any stronger than necessary to perform the required function, as this could for example result in overheating. If the device is to be incorporated in a container, then the reaction should be safely contained within the container to minimise any danger to the user.

It is therefore an aim of the invention to improve upon known heating devices.

According to a first aspect of the invention, there is provided a heating device based on an exothermic reaction between first and second substances, the device comprising a first cavity holding the first substance, a second cavity holding the second substance, and a first barrier layer therebetween, the device further comprising a rotatable breaking element for rotating to breach the first barrier layer, thereby allowing mixing of the first and second substances to start the reaction.

The breaking element may be configured to pierce the first barrier layer and move along the plane of the first barrier layer to rupture the first barrier layer upon rotation of the breaking element, thereby allowing the mixing of the first and second substances to start the reaction. The breaking element may comprise at least one prong for the piercing and moving along the plane of the first barrier layer, and the at least one prong may be offset from an axis of rotation of the breaking element.

The at least one prong may pierce and then rip or cut its way across the barrier layer to make a large aperture through which the first and second substances can quickly mix, with minimal need for shaking. The placement of the at least one prong at an offset position relative to the rotation of the breaking element allows the prong to be sufficiently slender to pierce the barrier layer and then move in a circular arc across its surface as the breaking element is rotated.

Advantageously, the at least one prong may comprise a plurality of prongs, preferable equally spaced apart from one another around the axis of the breaking element.

The breaking element may be configured to force the first barrier layer away from a seating between the first and second cavities when the breaking element is rotated, thereby breaching the first barrier layer and allowing the mixing of the first and second substances to start the reaction. The seating may for example be around an aperture between the first and second cavities, and the first barrier layer may keep the first and second substances apart from one another when the first barrier layer is fitted against the seating. When the breaking element is rotated the breaking element may force the barrier layer away from the seating and allow the first or second substances to move between the first barrier layer and the seating, from one of the first and second cavities to the other of the first and second cavities. The breaking element may comprise a screw thread for effecting the force against the first barrier layer as the breaking element is rotated.

Furthermore, the breaking element may be inside of the first cavity and the first cavity may have a circular cross-section to help support the rotation of the breaking element within the first cavity.

A second barrier layer may be provided over the first cavity, and the breaking element may be rotatable about an axis extending between the first and second barrier layers. Advantageously, the breaking element may comprise an engagement means for receiving a rotational force from an engagement element to rotate the breaking element relative to the first barrier layer. The engagement means may be adjacent to the second barrier layer so that is it easily accessible within the device.

The engagement means may be configured for receiving an engagement element having a tapered cross section, the tapered cross section for entering into the engagement means and then subsequently engaging with the engaging means as the engagement element is progressively moved into the engaging means. Then, the engaging means self-aligns with the engaging element as the engaging element is moved into the engaging means.

The device may be incorporated into a device compartment of a container, the container holding a contents to be heated, for example a beverage. Advantageously, the container may comprise a protrusion for severing the second barrier layer of the device. The protrusion may be an engagement element for engaging with the engaging means of the breaking element and supplying the rotational force. A taper towards a distal end of the protrusion may assist the protrusion in breaking through the second barrier layer.

The rotational position of the protrusion may be fixed relative to the device compartment and the device may be depressible within the device compartment such that the protrusion severs the second barrier layer of the device and becomes engaged with the engagement means. The engagement means may force the at least one prong to pierce the first barrier layer as the device is depressed in the device compartment, and may force the at least one prong of the breaking element to move along the plane of the first barrier layer to rupture the first barrier layer as the device is rotated in the device compartment and allow mixing of the first and second substances to start the reaction.

The depression and rotation of the device in the device compartment may occur substantially simultaneously, for example if the device is screwed into the device compartment.

In order to aid the engagement of the protrusion with the engagement means, the protrusion may comprise one or more tapered splines for first entering into an aperture of the breaking means, and then engaging with slots around the aperture to rotate the breaking means.

The device compartment and contents compartment may share a common wall so that heat is easily transferred between them. A third cavity may be formed by the common wall between the common wall and the device, the third cavity for receiving steam from the second barrier layer after the reaction has started, and for heating the contents in the contents compartment. The contents compartment may completely encircle the device compartment to aid heat transfer.

The container may be arranged so that the second barrier layer of the device is at an upper region of the device compartment with the container in its normally upright orientation, and wherein the third cavity leads to vent holes at a lower region of the device compartment. Then, steam passes out the top of the device, and downwards along the third cavity where it is cooled against the common wall between the device and contents compartments. Any excess pressure is released through the vent holes at the bottom after most of the steam energy has already been dissipated.

A base section for screwing onto the base of the container may also be provided. The base section may engage with the device to effect the depression and rotation of the device within the device compartment. The base section may comprise a well for collecting any condensation that is generated by the steam. An absorbent material may be placed in the well to help soak up any excess moisture.

Embodiments of the invention will now be described with reference to the accompanying drawings, in which:

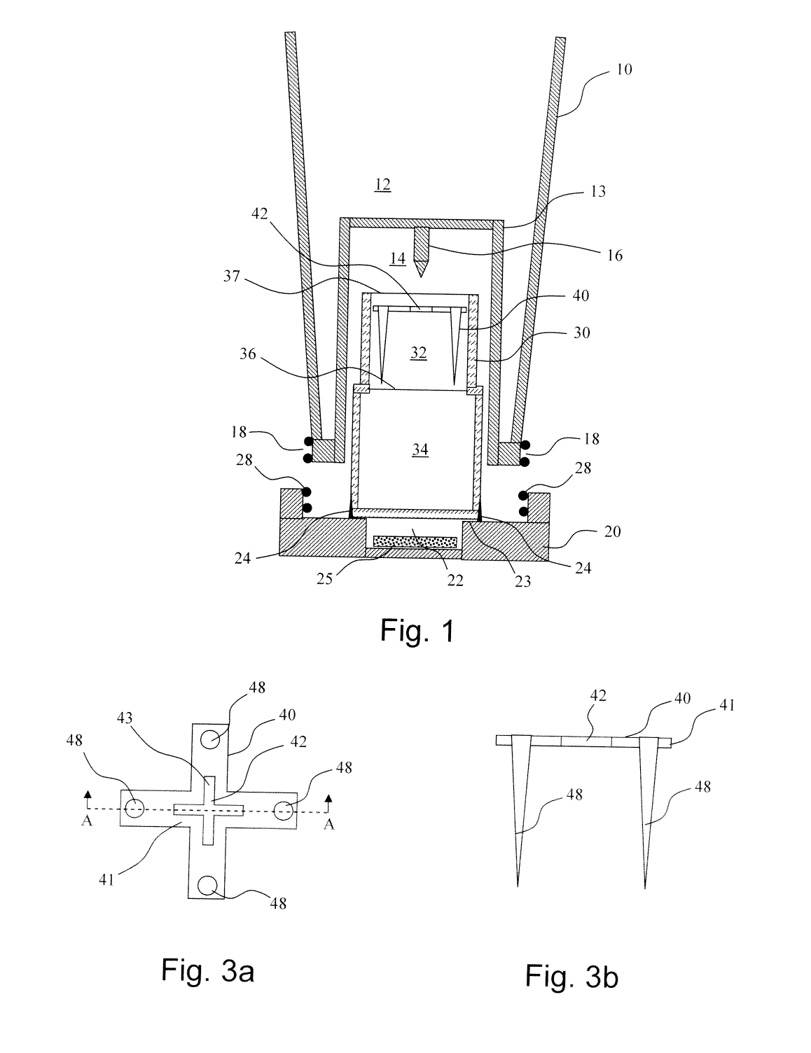

FIG. 1 shows a schematic cross-sectional diagram of a device and a container according to an embodiment of the invention;

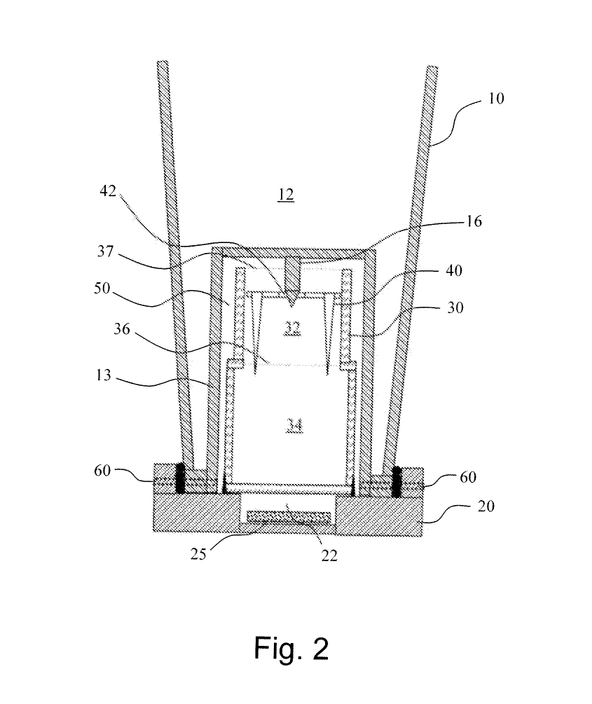

FIG. 2 shows a schematic cross-sectional diagram of the device and container of FIG. 1 in an actuated position;

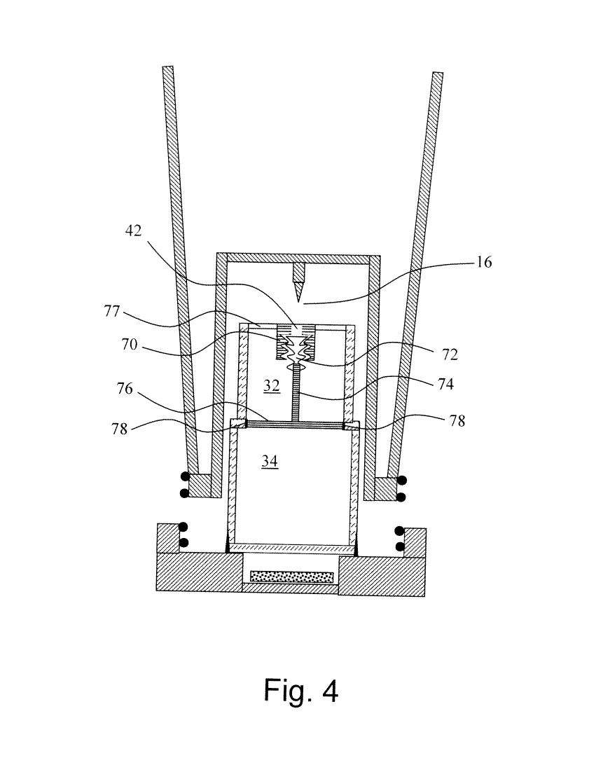

FIG. 3a shows a schematic plan diagram of a breaking element of the device shown in FIGS. 1 and 2;

FIG. 3b shows a schematic cross-sectional diagram of the breaking element of FIG. 3a;

FIG. 4 shows a schematic cross-sectional diagram of a device and a container according to a further embodiment of the invention; and

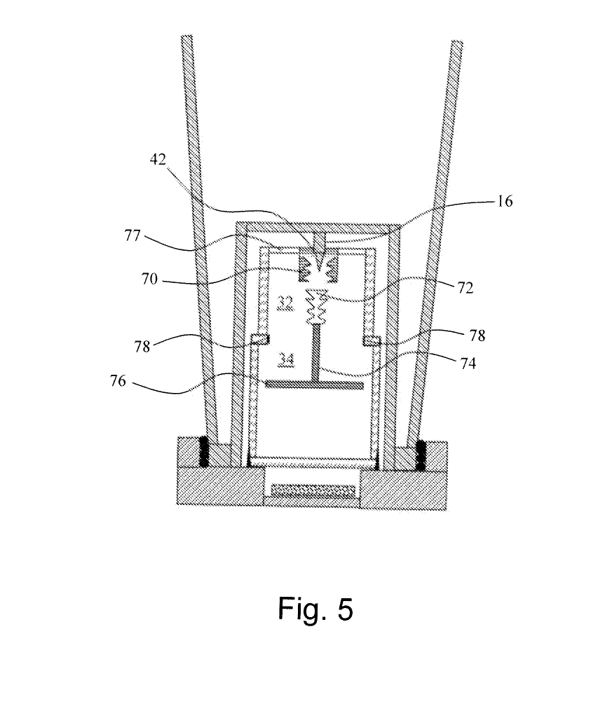

FIG. 5 shows a schematic cross-sectional diagram of the device and container of FIG. 4 in an actuated position.

The cross-sectional diagram of FIG. 1 shows a container 10 and a device 30 in an initial position prior to activating the exothermic reaction. The container 10 comprises a content compartment 12 and a device compartment 14. The content compartment 12 and device compartment 14 are formed by a common wall 13 of the container. In use, the content compartment may be filled with a food or beverage and heat from the device 30 in the device compartment can travel through the common wall 13 to heat the food or beverage.

The device 30 comprises a first cavity 32 and a second cavity 34 which hold first and second substances respectively (not shown in Figs). The first and second substances are kept apart from one another by a first barrier layer 36 in between the first 32 and second 34 cavities. The device 30 also comprises a second barrier layer 37 over the first cavity 32, and a breaking element 40 inside of the first cavity between the first and second barrier layers. The first 36 and second 37 barrier layers are made of aluminium foil, although other types of breakable barrier layers are obviously also possible.

The breaking element 40 comprises a plate and four prongs (two are visible in the cross sectional view of FIG. 1), and has an engagement means 42 by which a rotational force may be supplied to the breaking element 40 to rotate it inside the first cavity. The prongs point downwards towards the first barrier layer 36 and are capable of puncturing and cutting or ripping through the first barrier layer when the breaking element 40 is forced downwardly and rotated inside the first cavity.

The device compartment 14 has a protrusion 16 that acts as an engagement element for engaging with the engagement means 42 of the breaking element 40 when the protrusion 16 is forced through the second barrier layer 37 of the device 30.

The container 10 further comprises screw threads 18 onto which a base 20 may be screwed using base threads 28. The base comprises a platform 23 upon which the device 30 can rest, and some upstanding rods 24 in the form of steel pins that locate into slots in the sides of the device 30. The rods 24 fix the rotational position of the device 30 relative to the base 20. The rods may alternatively locate into holes or apertures in the device rather than into slots.

The base 20 further comprises a well 22 for collecting any condensation that forms as a result of the reaction between the first and second substances, and the well has an absorbent material 25 within it to soak up the collected condensation and enable easy removal of the condensation from the device.

The activation of the device 30 inside the device compartment 14 to heat contents in the contents compartment 12 will now be described with reference to FIG. 2. The device 30 is activated by screwing the base 20 onto the base of the container 10, and during the screwing the platform 23 of the base 20 forces the device 30 upwardly into the device compartment 14, and the rods 24 of the base 20 force the device 30 to rotate within the device compartment 14 in the same way as the base rotates as it is screwed onto the container.

As the device 30 begins to move into the device compartment 14, the protrusion 16 of the container 10 punctures the second barrier layer 37, and engages with the engagement means 42 of the breaking member 40 in the first cavity 32. The protrusion 16 exerts a downward force on the breaking member 40, causing the prongs to puncture the first barrier layer 36, and thereby beginning to release the first substance into the second cavity 34 where the first substance begins to react with the second substance to produce steam.

The protrusion 16 also exerts a rotational force on the breaking member 40, since the protrusion 16 is static in rotation whilst the device 30 is being rotated with the screwing of the base 20 onto the container. The protrusion 16 forces the breaking element 40 to stay static in rotation. Since the device 30 and therefore the first barrier layer 36 is being rotated, the prongs of the breaking element 40 rip and/or cut arcs along the plane of the first barrier layer 36, making a very large hole in the barrier layer and quickly releasing substantially all of the first substance into the second cavity. The first cavity 32 is tubular and has a circular cross section for supporting the rotation of the breaking element 40 within the tube.

Since substantially all of the first substance is released into the second cavity the reaction proceeds at full power, and hot steam forces its way out of the device 30 through the punctured second barrier layer 37 and into a third cavity 50 where it is freely circulates between the common wall 13 and the device. The steam condensates against the common wall 13, releasing its heat energy which is transmitted through the common wall 13 to the contents of the content compartment 12.

The steam travels from the second barrier layer 37 and down the third cavity 50 between the common wall 13 and the device where most of the heat energy is dissipated by condensation against the common wall. Any excess pressure inside the third cavity 50 is released through apertures 60 that are placed near the bottom of the third cavity where the temperature is lower than at the top of the third cavity.

The condensate from the steam drips down the common wall 13 and into the well 22, where it is soaked up by the absorbent material 25. The absorbent material 25 in this embodiment is a sponge, although other types of absorbent material are also possible.

Once the reaction has been completed, the base 20 may be unscrewed from the container 10 and the device 30 may be discarded. The container may then be re-used with another device the same as the device 30.

FIGS. 3a and 3b show a more detailed view of the breaking element 40 of the device 30. The plan view of FIG. 3a, which is taken from the direction the protrusion 16 approaches the breaking element 40, shows that the breaking element 40 comprises a plate 41 that is cut in the shape of a cross. Four prongs 48 are attached to each of the ends of the cross and extend perpendicular therefrom, as can be seen in the cross-sectional diagram of FIG. 3b that is taken along A-A marked on FIG. 3a.

The breaking element 40 has an engagement means in the form of an aperture 42 through the plate 41. The prongs 48 are offset from the engagement means so that their tips trace a circular path when the engagement means is used to rotate the breaking element 40.

The aperture 42 has four slots 43 extending from it in the shape of a cross. The protrusion 16 of the container is tapered to first enter the aperture 42, and then to enter the slots 43 as the protrusion is pushed further into the aperture 42 by the upward movement of the device 30. The protrusion 16 comprises four tapered splines (not shown in Figs) that progressively fill the four slots 43 to lock the rotation of the breaking element 40 with respect to the rotation of the protrusion 16 and to exert a downward force on the breaking element 40 as the protrusion 16 is pushed further against the aperture 42.

Many other types of protrusions and corresponding engagement means for locking the rotation of the breaking element relative to the protrusion will also be apparent to those skilled in the art.

A further embodiment of the invention will now be described with reference to FIGS. 4 and 5. FIG. 4 shows a schematic cross-sectional diagram of a device and container before the device has been placed into the container. The container and base of the container are the same as in the embodiment of FIGS. 1 and 2, and the device comprises first 32 and second 34 cavities having first and second substances (not shown in Figs) also the same as in the embodiment of FIGS. 1 and 2.

A first barrier layer 76 separates the first and second cavities apart from one another, and is a press-fit into a seating 78 that extends around the axis of the device between the first and second cavities. The seating 78 may be made of a resilient material that is compressed by the perimeter of the first barrier layer 76, to hold the first barrier layer 76 in place and to form a sufficiently good seal to stop the first and second substances from mixing with one another. A stem 74 extends from the first barrier layer 76 into the first cavity along the axis of the first cavity, and terminates in a head portion 72 that is provided with a screw thread.

A lid 77 acting as a second barrier layer is provided at an opposite side of the first cavity from the first barrier layer 77, and helps retain the first substance inside the first cavity. The lid 77 has a breaking element 70 that is rotatable relative to the lid 77 and the device. The breaking element 70 has an engagement means 42 the same as the engagement means of the embodiment of FIGS. 1 and 2, to receive a rotational force from the protrusion 16 of the container.

The breaking element 70 has an internal screw thread that is axially aligned beneath the engagement means 42. In the initial position of the device before mixing of the first and second substances, the head portion 72 that is connected to the first barrier member 76 via the stem 74, is screwed into the internal screw thread of the breaking element 70. The screw threads of the breaking element 70 and the head portion 72 fit sufficiently closely to prevent significant leakage of the first substance out of the first cavity, although a third barrier layer may be present over the engagement means 42 for extra security. The lid and third barrier layer could together be considered as a second barrier layer.

FIG. 5 shows a schematic cross-sectional diagram of the device and container after the device has been placed into the container and activated. Upon placing the device into the container by screwing the base into the container, the protrusion 16 of the container pierces the third barrier layer (if present) and locates into the engagement means 42.

As the device continues to be rotated by the screwing of the base into the container, the protrusion 16 exerts a rotational force on the engagement means 42 to fix the rotational position of the breaking member 70 relative to the container, making the breaking member 70 rotate relative to the device and the head portion 72, unscrewing the head portion 72 and forcing the first barrier layer 76 out of the seating 78 and into the second cavity. This breaches the first barrier layer 76 and the first substance falls around the sides of the first barrier layer 76 into the second cavity where it reacts with the second substance.

The reaction generates steam, which travels out of the device via the now-open hole in the breaking element where the head portion 72 used to be before the un-screwing. The steam moves out of the breaking element 70 and into the third cavity between the common wall of the container and the device, where it condensates to release heat in the same manner of the embodiment of FIGS. 1 and 2.

The first barrier layer 76 is prevented from rotating relative to the device by virtue of having a non-circular shape, or by having ridges cut in the same direction as the axis of the stem that press into the resilient seating 78. If the first barrier layer were to rotate relative to the device then the unscrewing of the heat portion 72 from the breaking member 70 may not be achieved.

The breaking member 70 could alternately have an external screw thread with the head portion 72 of the stem having an internal screw thread, the head portion blocking a hole of the breaking member until it was unscrewed.

In the described embodiments, the first substance is a saline solution and the second substance is a magnesium metal with electrolytic iron powder and silica. The mixing of these first and second substances results in steam, magnesium hydroxide and gaseous hydrogen. Other types of first and second substances such as calcium oxide and water will also be apparent to those skilled in the art.

In the described embodiments, the heating device supplies heat to provide warming, although in other embodiments the heat may be converted to motive force, for example by directing steam that is output by the device through a turbine.

The devices of the described embodiments are rotatable within the device compartment of the container and the protrusion is fixed within the container so that protrusion can supply a rotational force to the breaking element of the device. However, in alternate embodiments the rotational position of the device may be fixed relative to the container and the protrusion may be rotated relative to the container and the device to supply a rotational force to the breaking element of the device.

Further alternate embodiments falling within the scope of the appended claims will also be apparent to the skilled person.

1. An apparatus comprising a container and a heating device, the heating device based on an exothermic reaction between first and second substances, the heating device comprising a first cavity holding the first substance, a second cavity holding the second substance, and a first barrier layer therebetween, the apparatus further comprising a rotatable breaking element for rotating to breach the first barrier layer, thereby allowing mixing of the first and second substances to start the reaction.

2. The apparatus of claim 1, wherein the breaking element is configured to pierce the first barrier layer and move along the plane of the first barrier layer to rupture the first barrier layer upon rotation of the breaking element, thereby allowing the mixing of the first and second substances to start the reaction.

3. The apparatus of claim 2, wherein the breaking element comprises at least one prong offset from an axis of rotation of the breaking element, the at least one prong configured for the piercing of the first barrier layer and the moving along the plane of the first barrier layer to rupture the first barrier layer.

4. The apparatus of claim 3, wherein the at least one prong comprises a plurality of prongs that are equally spaced from one another around the axis of the breaking element.

5. The apparatus of claim 1, wherein the breaking element is configured to force the first barrier layer away from a seating between the first and second cavities when the breaking element is rotated, thereby breaching the first barrier layer and allowing the mixing of the first and second substances to start the reaction.

6. The apparatus of claim 5, wherein the breaking element is configured to rotate within a lid of the first cavity at the opposite side of the first cavity from the first barrier layer, the breaking element having a screw thread.

7. The apparatus of claim 6, further comprising a stem extending from the first barrier layer, the stem comprising a head portion having a screw thread that is un-screwable from the screw thread of the breaking element.

8. The apparatus of claim 1, wherein the breaking element comprises an engagement member to engage with an engagement element and receiving a rotational force from the engagement element to rotate the breaking element relative to the first barrier layer.

9. The apparatus of claim 8, wherein the engagement member is configured for receiving an engagement element having a tapered cross section, the tapered cross section for entering into the engagement member and then subsequently engaging with the engaging member as the engagement element is progressively moved into the engaging member.

10. The apparatus of claim 1, wherein the rotatable breaking element is inside of the first cavity and wherein the first cavity is tubular and comprises a region with a circular cross section for supporting the rotation of the breaking element.

11. The apparatus of claim 1, wherein the heating device further comprises a second barrier layer over the first cavity, the breaking element being between the first and second barrier layers.

12. The apparatus of claim 11, wherein the breaking element is rotatable about an axis extending between the first and second barrier layers.

13. The apparatus of claim 1, wherein the container comprises a contents compartment for holding a contents to be heated and a device compartment for holding the heating device, wherein the device compartment comprises a protrusion for severing the second barrier layer of the heating device.

14. The apparatus of claim 13, wherein the protrusion is an engagement element configured for engaging with the engaging means of the breaking element for supplying the rotational force thereto.

15. The apparatus of claim 13, wherein the rotational position of the protrusion is fixed relative to the heating device compartment and wherein the heating device is depressible and rotatable within the device compartment such that the protrusion severs the second barrier layer of the heating device and becomes engaged with the engagement means, and the engagement means causes the at least one prong of the breaking element to pierce the first barrier layer and to move along the plane of the first barrier layer to rupture the first barrier layer allowing mixing of the first and second substances to start the reaction.

16. The apparatus of claim 13, wherein a common wall of the container is common to the contents compartment and the device compartment, and wherein the common wall forms a third cavity between the common wall and the heating device, the third cavity for receiving steam from the second barrier layer to heat the contents in the contents department after the reaction has started.

17. The apparatus of claim 16, wherein the second barrier layer is at an upper region of the device compartment with the container in its normally upright orientation, and wherein the third cavity leads to vent holes at a lower region of the device compartment.

18. The apparatus of claim 13, further comprising a base section for screwing onto a base of the container, wherein the base section comprises device engagement means for engaging the heating device and effecting the depression and rotation of the heating device within the device compartment.

19. The apparatus of claim 18, wherein the base section comprises a well for collecting condensation that is generated by steam in the third cavity.

20. The apparatus of claim 18, wherein the device engagement means comprise a platform upon which the heating device rests and a plurality of rods that are spaced around the platform that engage slots or apertures of the heating device to fix the rotation of the heating device relative to the base.

21. (canceled)

22. (canceled)
